(19) United States
(12) Patent Application Publication
(10) Pub. No.: US 2008/0147517 A1
(43) Pub. Date: Jun. 19, 2008

(54) CHANGE AGGREGATION VIA TIMESTAMPS

(75) Inventors: ANDREA C. MARTINEZ, POUGHKEEPSIE, NY (US); CHARLES MATULA, POUGHKEEPSIE, NY (US); DAVID H. STARKE, POUHKEEPSIE, NY (US); GREGORY R. E. WILEY, WAPPINGERS FALLS, NY (US)

Correspondence Address: DELIO & PETERSON, LLC, 121 WHITNEY AVENUE, NEW HAVEN, CT, 06510, US

(73) Assignee: INTERNATIONAL BUSINESS MACHINES CORPORATION, Armonk, NY (US)

(21) Appl. No.: 11/538,865

(22) Filed: Oct. 5, 2006

(51) Int. Cl. G06Q 10/00

(52) U.S. Cl. 705/28

(57) ABSTRACT

A method of aggregating changes in an order status database system teaching the method steps of identifying the order and the order status, where the order status includes an insert timestamp and an update timestamp; identifying individual line items (products) that together form the order, each line item identifying the quantity requested, quantity shipped, and status shipped, with individual insert timestamps and update timestamps; and updating the order and line item insert and update timestamps whenever a line item is updated.

### BACKGROUND OF THE INVENTION

1. Field of the Invention

This invention relates generally to monitoring systems that undergo aggregate changes, such as inventory control systems. Specifically, the invention relates to the fulfillment of an order status system for fulfilling orders, and monitoring the change aggregation using timestamps.

2. Description of Related Art

One aspect of many businesses is to accept and fulfill orders. Orders generally contain line items identifying certain products have been requested and that need to be addressed in a timely manner. The line items generally contain the identification of the products being purchased and the quantity of each product selected. Normally, businesses will attempt to fill the orders as product becomes available. If there is inventory on hand to ship, the line item representing that particular product may be separated and shipped independently of other products that are not available for immediate shipment. As inventory becomes available, the remaining quantity of each product identified is shipped in fulfillment of the order.

Orders and line items are particular examples of business objects. Business objects generally have attributes that change over time. Tracking these changes is one of the primary responsibilities of an order status system. For exemplary purposes, the order status system attributes considered are order number, order status, line number, product, quantity ordered, quantity shipped, and shipment status. However, the description is equally applicable to the more general attributes normally consistent with order status systems.

FIG. 1 depicts the status of an order as monitored through a relational database. In this example, a customer orders five servers and three hard drives. This is normally represented as one order 12 with two line items 14, 16. Line item 12 is found in the relational database at line number 10, and identifies the product as “server”, the quantity ordered as “5”, the quantity shipped as “0”, and the status of the order as “received.” Line item 16 is found in the relational database at line number 20, and identifies the product as “hard drive”, the quantity ordered as “3”, the quantity shipped as “0”, and the status of the order for this particular product as “received.” The order 12 is identified as order number “0001”, and depicts a status of “received” for the two accompanying line items. For this example, it is assumed that there is inventory on hand to ship three servers and two hard drives. Upon receipt, these items are assumed to be immediately shipped. FIG. 2 depicts the order status 22 after the inventoried items have been shipped. Because some items have been shipped, the order status is designated ‘partially shipped.’ Line item 24 indicates three of the five requested servers were shipped, and that the line item status is also ‘partially shipped.’ Line item 26 shows that two hard drives of the requested three hard drives have been shipped. This line item is also designated as ‘partially shipped.’

Continuing the example, when an additional server becomes available and is shipped, the relational database details an updated status. FIG. 3 depicts the relational database output of FIG. 2 when an additional server is shipped. The order status 32 will remain unchanged, indicating that order no. 0001 is still ‘partially shipped.’ Line item 34 now represents the additional server shipped, showing that four out of a possible five servers have been shipped. This line item is still listed as ‘partially shipped.’ Line item 36, representing the hard drive status, remains unchanged, and is listed as ‘partially shipped.’

When another hard drive becomes available, the relational database is again updated. FIG. 4 depicts the relational database of FIG. 3 when an additional hard drive is shipped. The order status 42 remains unchanged, insomuch as the entire order is still not completed (one more server is required). Line item 46 shows that the hard drive order has been completed, and its individual status has been updated to ‘shipped.’ Line item 44 lets the supplier know that the order is not completed in its entirety because the fifth server has not been shipped.

FIG. 5 depicts the relational database output of FIG. 4 when the remaining server ships and the order status is complete. The order status 52 will indicate that all products for order no. 0001 have shipped, along with each individual line item 54, 56 verification.

Normally, users monitor the Order section when an order changes. However, when a user is noticed of an order change, the Order section depicted in FIGS. 2, 3 and 4 (24, 34, and 44, respectively) continues to indicate only a ‘partially shipped’ status, and thus, remains unchanged. This is because the complete order will remain on ‘partially shipped’ status until all items are shipped. Consequently, the prior art process of monitoring the Order table alone misses important changes to the business object.

### SUMMARY OF THE INVENTION

Bearing in mind the problems and deficiencies of the prior art, it is therefore an object of the present invention to provide a method of notifying a user through a relational database output when an order status changes.

It is another object of the present invention to provide a method for updating order status in a relational database that takes into account the continuing updating of certain line items in progress.

Still other objects and advantages of the invention will in part be obvious and will in part be apparent from the specification.

The above and other objects, which will be apparent to those skilled in the art, are achieved in the present invention, which is directed to a method of aggregating changes in an order status database system comprising: identifying an order and a current order status; identifying individual line items that together form the order, wherein the individual line items include a quantity requested, a quantity shipped, and a shipping status; applying timestamps identifying an initial time of insertion and an update time for the order and each of the individual line items; updating the timestamps, the current order status, and the line item shipping status, whenever a line item is updated; and displaying the order and the individual line items with the insert timestamps, the update timestamps, the current order status, and the line item shipping status. The order may be identified by an order number. The individual line items may each be associated with individual products. The current status order and the line item shipping status include categories to identify orders and line items that are received, partially shipped, or shipped. The timestamps may include time and date information. Updating the line item may include identifying a time and date when the line item has been shipped in fulfillment or partial fulfillment of the order. The method further includes updating the quantity shipped whenever an additional line item is shipped. The method may be performed in the database system software using SQL.

In a second aspect, the present invention is directed to a method of aggregating changes in an order status database system comprising: identifying and displaying order level information; identifying and displaying line item information, such that the sum of individual line item information represents a total for the order level information; and implementing SQL to aggregate timestamps for the line items up to the order level.

The order level information may include an order number, an order status, an order insert timestamp, and an order update timestamp. The line item information may include a line number, a product identifier, quantity ordered, quantity shipped, a line item status, a line item insert timestamp, and a line item update timestamp. The order status may include categories to identify orders that are received, partially shipped, or shipped.

In a third aspect, the present invention is directed to a program storage device readable by a machine, tangibly embodying a program of instructions executable by the machine to perform method steps for aggregating changes in an order status database system, the method steps comprising: identifying an order and a current order status; identifying individual line items that together form the order, wherein the individual line items include a quantity requested, a quantity shipped, and a shipping status; applying timestamps identifying an initial time of insertion and an update time for the order and each of the individual line items; updating the timestamps, the current order status, and the line item shipping status, whenever a line item is updated; and displaying the order and the individual line items with the insert timestamps, the update timestamps, the current order status, and the line item shipping status.

### BRIEF DESCRIPTION OF THE DRAWINGS

The features of the invention believed to be novel and the elements characteristic of the invention are set forth with particularity in the appended claims. The figures are for illustration purposes only and are not drawn to scale. The invention itself, however, both as to organization and method of operation, may best be understood by reference to the detailed description which follows taken in conjunction with the accompanying drawings in which:

FIG. 1 depicts the status of an order as monitored through a relational database.

FIG. 2 depicts the order status of FIG. 1 after inventoried items have been shipped.

FIG. 3 depicts the relational database output of FIG. 2 when an additional server is shipped.

FIG. 4 depicts the relational database of FIG. 3 when an additional hard drive is shipped.

FIG. 5 depicts the relational database output of FIG. 4 when the remaining server ships.

FIG. 6 depicts a relational database representation of an order with insert and update timestamps applied to the order status and to each line item designator.

FIG. 7 depicts the relational database output of the order of FIG. 6, reflecting the immediate shipment of three servers and two hard drives.

FIG. 8 depicts the relational database output of FIG. 7 with an additional server shipped at a later time.

FIG. 9 represents the order of FIG. 8 after another hard drive becomes available and has been shipped.

FIG. 10 depicts the final relational database output of the present invention when the last line item is designated as shipped.

### DESCRIPTION OF THE PREFERRED EMBODIMENT(S)

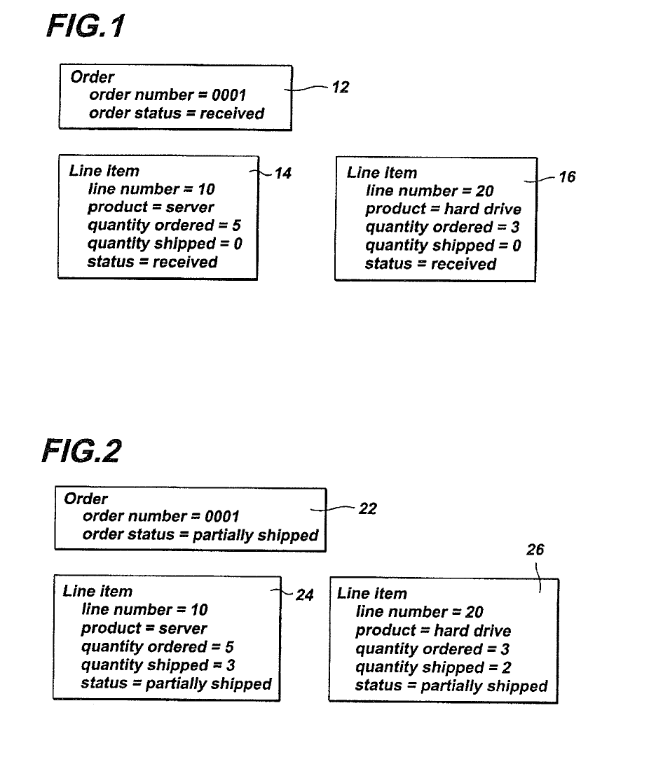

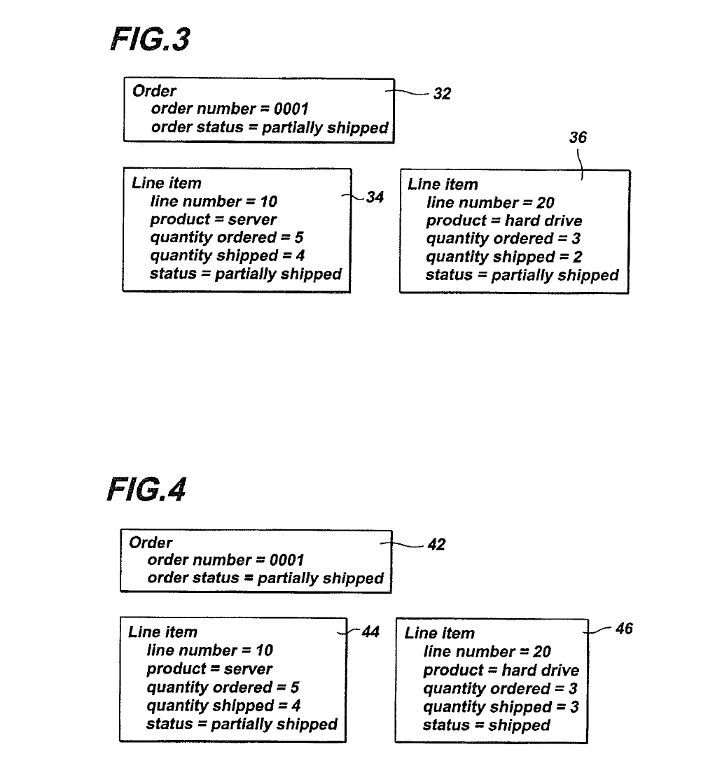

In describing the preferred embodiment of the present invention, reference will be made herein to FIGS. 1-10 of the drawings in which like numerals refer to like features of the invention.

The present invention addresses the issue of relational database status when only a portion of the order is satisfied. Two date/time columns are added to each row in the database table. These date/time columns are generally referred to as ‘timestamps,’ and represent the time the row was inserted into the database, and the time the row was last updated. The example above is discussed below with the additional implementation of the insert and update timestamps.

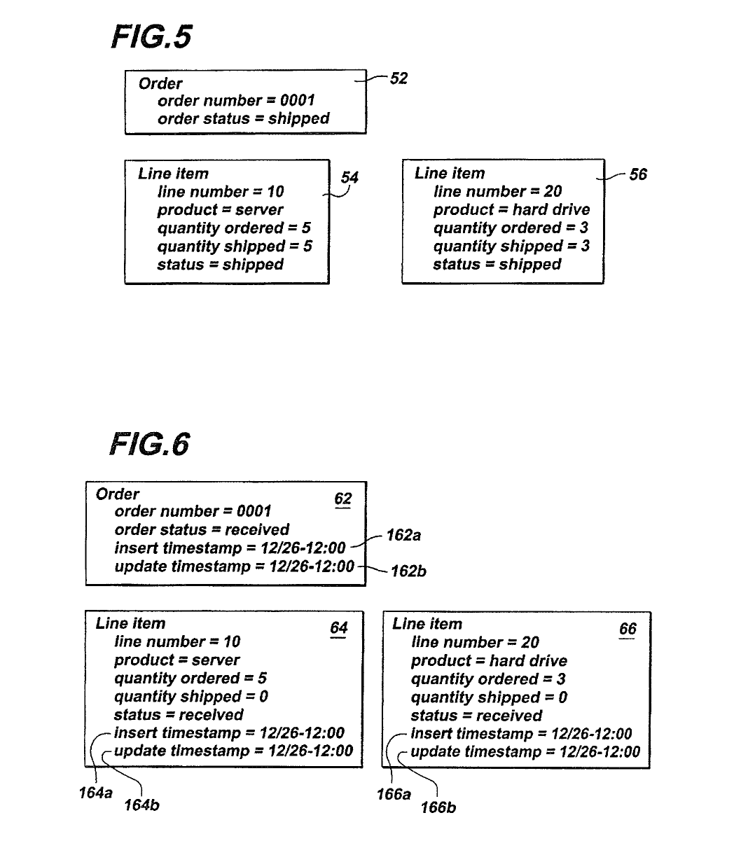

FIG. 6 depicts a relational database representation of an order with insert and update timestamps applied to the order status 62 and to each line item designator 64, 66. In similar fashion to the prior art example, a customer orders five servers and three hard drives. This is represented as one order 62 having two line items 64, 66. Line item 62 represents the five servers at line 10. Line item 64 represents the hard drives at line 20. Both line items indicate a status of received and no quantities shipped. In all instances, the order status is ‘received.’ Order status 62 shows an insert timestamp 162a and update timestamp 162b. Line item 64 has an insert timestamp 164a and an update timestamp 164b. Line item 66 has an insert timestamp 166a and an update timestamp 166b. In this first instance, each insert timestamp and update timestamp are shown with similar data: December 26 at 12:00.

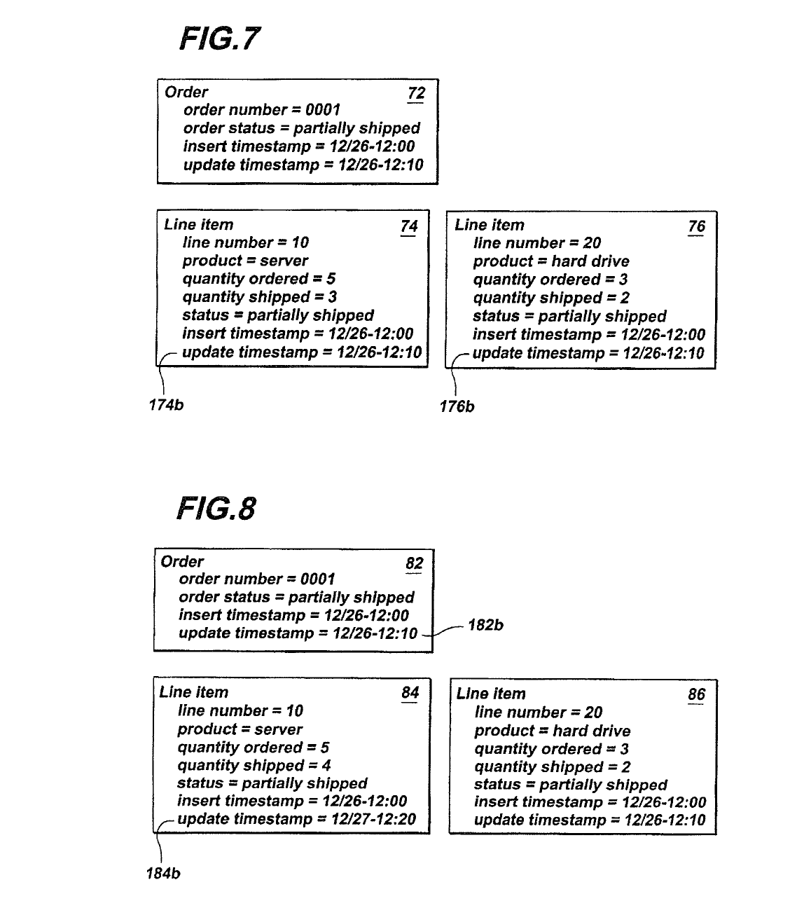

In a similar fashion to the previous example, there is inventory on hand to ship three servers and two hard drives, so these products are immediately shipped and the relational database is updated accordingly with the additional information for an update timestamp included. FIG. 7 depicts the relational database output reflecting the immediate shipment of three servers and two hard drives. Order status 72 indicates that order no. 0001 is ‘partially shipped’ because the individual orders for both product types, line items 74, 76, are not fulfilled. Line item 74, representing the server product shows a partial shipment of three units and an update timestamp 174b of 12:10. Line item 76, representing the hard drive product reflects the partial shipment of two hard drives, and also includes an update timestamp 176b of 12:10.

Another server becomes available and is shipped out. FIG. 8 depicts the relational database output of FIG. 7 with an additional server shipped at a later time. Since order status 82 has not been updated, it retains its timestamp 182b, as 12/26-12:10. Only when the order block 82 is updated is its timestamp accordingly updated. Line item 84 indicates the additional, fourth server shipped at the new update timestamp 184b of 12/27-12:20. Line item 86 remains unchanged. From this output, the user is aware by viewing only the Order status block 82 that the order is not yet complete (‘partially shipped’).

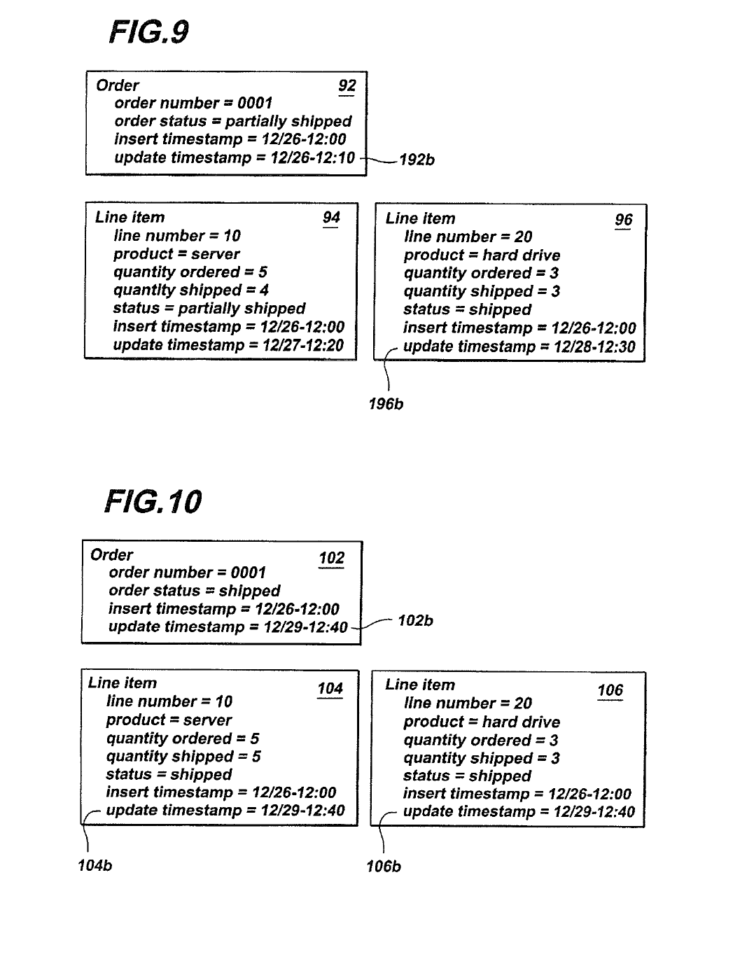

FIG. 9 represents the order of FIG. 8 after another hard drive becomes available and has been shipped. The order status block 92 shows the order is still ‘partially shipped’, since the order represented by line item 94 for servers is not yet completed. Line item 96 indicates that the quantity of hard drives ship equals the quantity of hard drives ordered, thus updating the status to ‘shipped,’ and showing the update timestamp 196b for shipping the last hard drive as 12/28-12:30. The order status block 92 depicts the latest update to the shipping, which is the same as it was previously displayed since the order status has not changed. Although a line item within the order has been updated, unless the order status designates a change in shipment, i.e., from “partially shipped” to “shipped,” the order status block timestamp remains in its previous state.

When the remaining server ships, the relational database output is updated for a final tally. Order status 102 depicts the order status as ‘shipped’, with the latest update timestamp reflecting the last update of the remaining line item 104. Line item 104 is updated to show its status as ‘shipped’ and the last time activity was initiated, as indicated by update timestamp 104b. FIG. 10 depicts the final relational database output of the present invention when the last line item is designated as shipped.

The above-identified example is shown for exemplary purposes only, and the present invention is not limited to the presentation of the information currently listed in the example, such as order number, order status, product, quantity ordered, quantity shipped, line item status, and timestamps. The present invention may accommodate the identification of multiple data designators, product descriptors, and the like, that will meet the user's informational requirements. Additionally, the present invention may accommodate a system that publishes changes or updates, and is used to keep track of the most recent time that a change has been published, its publication time. When changes are published, the system is used to easily determine which orders have changed by identifying the orders that have an update timestamp after the last publication time.

Implementation of the present invention will enable hierarchical change aggregation in SQL. At each level of the hierarchy aggregate, the earliest insert and the latest update for all data at a given level of information or below, are displayed with the status indicators. Through the computerized inspection of the aggregates, the change aggregation may be determined and accomplished. Preferably, the following type of algorithm or other equivalent may be used to aggregate line-level time stamps up to an Order level.

```
WITH
ORDER_DATA AS
(
  SELECT
      O.ID,
      O.ORDER_DATA_INS,
      O.ORDER_DATA_UPD
  FROM
      ORDER_TABLE O
),
LINE_DATA AS
(
  SELECT
      L.ID,
      L.ORDER_ID,
      L.LINE_DATA_INS
      L.LINE_DATA_UPD,
  FROM
      LINE_ITEM_TABLE L
      INNER JOIN ORDER_DATA OD ON (OD.ID = L.ORDER_ID)
),
ORDER_TS AS
(
  SELECT
      L.ORDER_ID,
      MIN( O.ORDER_DATA_INS ) AS ORDER_INS_TS,
      MAX( O.ORDER_DATA_UPD ) AS ORDER_UPD_TS
  FROM
      LINE_DATA
  GROUP BY
      L.ORDER_ID
)
  SELECT
      O.ID
      OTS.ORDER_INS_TS,
      OTS.ORDER_UPD_TS
  FROM
      ORDER_DATA O
      INNER JOIN ORDER_TS OTS ON ( OTS.ORDER_ID = O.ID)
```

The above-described algorithm is for exemplary purposes only. Other software subroutines may be employed, obtaining similar results through different coded functions. The present invention is not limited to any one particular type of software code, nor is it relegated to any one particular suite of functions to obtain the resultant output.

The algorithms used to achieve the resultant output are engaged in performing the following functions, or functions of an equivalent nature: a) identifying the order and the order status, where the order status includes an insert timestamp and an update timestamp; b) identifying individual line items (products) that together form the order, each line item identifying the quantity requested, quantity shipped, and status shipped, with individual insert timestamps and update timestamps; and c) updating the order and line item insert and update timestamps whenever a line item is updated.

While the present invention has been particularly described, in conjunction with a specific preferred embodiment, it is evident that many alternatives, modifications and variations will be apparent to those skilled in the art in light of the foregoing description. It is therefore contemplated that the appended claims will embrace any such alternatives, modifications and variations as falling within the true scope and spirit of the present invention.

Thus, having described the invention,

What is claimed is:

1. A method of aggregating changes in an order status database system comprising:
identifying an order and a current order status;
identifying individual line items that together form said order, wherein said individual line items include a quantity requested, a quantity shipped, and a shipping status;
applying timestamps identifying an initial time of insertion and an update time for said order and each of said individual line items;
updating said timestamps and said line item shipping status, whenever a line item is updated;
updating said current order status and associated timestamp when said order status has changed; and
displaying said order and said individual line items with said insert timestamps, said update timestamps, said current order status, and said line item shipping status.

2. The method of claim 1 wherein said order is identified by an order number.

3. The method of claim 1 wherein said individual line items are each associated with individual products.

4. The method of claim 1 wherein said current status order and said line item shipping status include categories to identify orders and line items that are received, partially shipped, or shipped.

5. The method of claim 1 wherein said timestamps comprise time and date information.

6. The method of claim 1 wherein updating said line item includes identifying a time and date when said line item has been shipped in fulfillment or partial fulfillment of said order.

7. The method of claim 6 further comprising updating said quantity shipped whenever an additional line item is shipped.

8. The method of claim 1 further comprising performing said method in said database system software using SQL.

9. A method of aggregating changes in an order status database system comprising:
identifying and displaying order level information;
identifying and displaying line item information, such that the sum of individual line item information represents a total for said order level information; and
implementing SQL to aggregate timestamps for said line items and said order level information.

10. The method of claim 9 wherein said order level information includes an order number, an order status, an order insert timestamp, and an order update timestamp.

11. The method of claim 9 wherein said line item information includes a line number, a product identifier, quantity ordered, quantity shipped, a line item status, a line item insert timestamp, and a line item update timestamp.

12. The method of claim 10 wherein said order status includes categories to identify orders that are received, partially shipped, or shipped.

13. The method of claim 11 wherein said line item status includes categories to identify line items that are received, partially shipped, or shipped.

14. The method of claim 9 wherein said timestamps comprise time and date information.

15. The method of claim 9 identifying a time and date when said line item has been shipped in fulfillment or partial fulfillment of said order.

16. The method of claim 15 further comprising updating said quantity shipped whenever an additional line item is shipped.

17. A program storage device readable by a machine, tangibly embodying a program of instructions executable by the machine to perform method steps for aggregating changes in an order status database system, said method steps comprising:
identifying an order and a current order status;
identifying individual line items that together form said order, wherein said individual line items include a quantity requested, a quantity shipped, and a shipping status;
applying timestamps identifying an initial time of insertion and an update time for said order and each of said individual line items;
updating said timestamps, and said line item shipping status, whenever a line item is updated;
updating said current order status and associated timestamp when said order status has changed; and
displaying said order and said individual line items with said insert timestamps, said update timestamps, said current order status, and said line item shipping status.

18. The program storage device of claim 17 wherein said current status order and said line item shipping status include categories to identify orders and line items that are received, partially shipped, or shipped.

19. The method of claim 17 wherein updating said line item includes identifying a time and date when said line item has been shipped in fulfillment or partial fulfillment of said order.

20. The method of claim 19 further comprising updating said quantity shipped whenever an additional line item is shipped.
